(19) United States
(12) Patent Application Publication
(10) Pub. No.: US 2001/0038276 A1
(43) Pub. Date: Nov. 8, 2001

(54) Device for charging a starting battery in a vehicle

(76) Inventors: Oivind Resch, Bekkestua (NO); Tore Lervik, Sellebakk (NO)

Correspondence Address: Finnegan, Henderson, Farabow,, Garrett & Dunner, L.L.P., 1300 I Street, N.W., Washington, DC, 20005-3315, US

(21) Appl. No.: 09/811,623

(22) Filed: Mar. 20, 2001

(30) Foreign Application Priority Data
Mar. 20, 2000 (NO) 20001443

(51) Int. Cl. H02J 7/04

(52) U.S. Cl. 320/150

(57) ABSTRACT

The invention relates to a device (1) for charging a starting battery in a vehicle. The device comprises a number of chargeable emergency battery units (3a, 3b), control circuits for controlling a first charging process for charging the starting battery (2) and for controlling a second charging process for charging the emergency battery units (3a, 3b), and connecting devices (5) for electrical connection to a circuit in which the starting battery (2) is included. The control circuits comprise a checking device (6), arranged for measuring the starting battery's voltage and a voltage for at least one of the emergency battery units, and arranged for controlling at least one of the first and the second charging processes as a function of at least these voltages. In addition the control device (6) comprises a first temperature sensor device (51) for measuring a temperature at or near an emergency battery unit, and is arranged for controlling at least one of the first and the second charging processes as a function of this temperature.

### TECHNICAL FIELD

The invention relates in general to battery charging, and more specifically to a device for charging a starting battery in a vehicle.

### BACKGROUND OF THE INVENTION

A phenomenon which is well known to drivers and owners of motor vehicles is that for a variety of reasons the starting battery can become run down, with the result that there is no longer any electrical energy for running the electrical starting motor in the vehicle.

In a situation of this kind a well-known remedy is to obtain electrical energy from an external, electrical energy source, for example from another vehicle's starting battery by means of so-called starter cables.

Another solution is to couple an external energy source with considerably less capacity than an external starting battery to a circuit in which the vehicle's starting battery is included. The energy source may be in the form of an emergency battery, for example a disposable battery package. An emergency battery of this kind may, for example, be coupled to a cigarette lighter contact in the vehicle. The starting motor will require a current which is so great that it cannot be drawn directly from the emergency battery. The emergency battery therefore has to be connected to the starting battery over a certain period of time in order to ensure that sufficient electrical energy is transferred to the starting battery to enable the starting motor subsequently to be operated from the starting battery.

When charging a chargeable battery, a charging voltage must be provided which is higher than the nominal voltage for the battery. For example, it is well known that when charging a 12V lead accumulator, a voltage should be employed which is higher than 12V, for example between 13.8V and 148V, or even higher.

### RELATED BACKGROUND ART

A number of devices of the type mentioned in the introduction are known in the prior art. Several of these known devices are equipped with a chargeable emergency battery, thus enabling the devices to be employed several times. Some of the known devices can also be charged from the vehicle's starting battery, preferably during a period when the starting battery has reached a state where it has received a substantial electrical charge. An example of such a device is disclosed in U.S. Pat. No. 5,637,978.

In this previously known device the emergency battery's nominal voltage is less than or equal to that of the starting battery. In order to obtain sufficient voltage for charging the starting battery by “dumping”, i.e charging the starting battery, the known device comprises a boost circuit which increases the voltage to an adequate charging voltage. The reverse process, i.e. charging the emergency battery, is performed by means of a connection directly or via a resistor from the vehicle's charging system, which when the engine is running has sufficiently high voltage, to the emergency battery. Alternating between “dumping” and charging of the emergency battery is performed by means of a switch 13.

A first disadvantage of the known device is that the limited energy which exists in the emergency battery in its charged state is not fully exploited, since the course of the “dump” charging does not proceed in a controlled manner, nor does it take into consideration the different conditions in the emergency battery, the starting battery and the surroundings.

A second disadvantage of the known device is that the limited energy which exists in the emergency battery in its charged state is not fully exploited on account of substantial energy loss in the boost circuit which is employed in order to obtain sufficiently high voltage for charging the starting battery.

A third disadvantage of the known device is that it contains mechanical components, including at least a switch for alternating between “dump” charging and the reverse charging process.

A fourth disadvantage of the known device is that it employs a lead accumulator as an emergency battery. This results in the device having relatively little electrical capacity per weight and volume unit and provides a limited maximum power output during the course of “dump” charging.

A fifth disadvantage of the known device is that it does not include means whereby it can itself indicate when it has reached a state in which it should be charged in order to be functional.

### SUMMARY OF THE INVENTION

It is an object of the present invention to provide a device for charging a starting battery in a vehicle, whereby the charging process is automatically controlled.

It is a further object of the present invention to provide a device for charging a starting battery in a vehicle, wherein the energy in the emergency battery is favorably exploited during the charging of the starting battery.

It is an additional object of the present invention to provide a device for charging a starting battery in a vehicle, wherein the use of operating elements and mechanical components is reduced to a minimum, in order to improve operational reliability and simplicity.

It is a further object of the present invention to provide a device for charging a staring battery in a vehicle, which is inexpensive, safe, easy to connect and easy to operate in various surrounding conditions.

According to the invention, the above and additional objects are achieved by a device for charging a starting battery in a vehicle, comprising a number of chargeable emergency battery units, control circuits for controlling a first charging process for charging the starting battery and for controlling a second charging process for charging the emergency battery units, connecting devices for electrical connection to a circuit in which the starting battery is included, wherein the control circuits comprise a control device which is arranged for comparing the starting battery's voltage and a voltage for at least one of the emergency battery units, and further arranged for controlling at least one of the first and the second charging processes as a function of at least this comparision, and wherein the control device comprises a first temperature sensor device for measuring a temperature at or near an emergency battery unit and is arranged for controlling at least one of the first and the second charging processes as a function of this temperature.

According to a preferred embodiment, the device according to the invention comprises at least two emergency battery units, each with nominal voltage less than the starting battery's nominal voltage. In this case, the control circuits for controlling the first charging process comprise electronic switch devices in order to connect the at least two emergency battery units in series for periods during the first charging process, and the control circuits for controlling the second charging process comprise electronic switch devices in order to connect the at least two emergency battery units in parallel for periods during the second charging process.

Alternatively, the device comprises one emergency battery unit, where the emergency battery unit has higher nominal voltage than the starting battery's nominal voltage. In this embodiment, the control circuits for controlling the first charging process comprise circuits arranged to connect the emergency battery unit directly to the connecting device against the starting battery for periods during the first charging process, and the control circuits for controlling the second charging process comprise a direct voltage converter circuit in order to supply a charging voltage to the emergency battery unit, which is higher than the starting battery's voltage for periods during the second charging process.

Advantageously, the control device comprises a second temperature sensor device for measuring an ambient temperature, and is arranged for controlling at least one of the first and the second charging processes as a function of this temperature.

Advantageously, the control device includes a first electrical output for transmitting a signal indicating that the first charging process is in progress, and the device comprises a first indicator connected to the said first output.

Advantageously, the control device includes a second electrical output for transmitting a signal indicating that the charge contained in the emergency batteries is below a given limit value, and the device includes a second indicator connected to the said second output.

Advantageously, the control device includes a microcontroller, comprising a processing unit at least one storage device, and input and output circuits, where the storage device comprises an area containing a program with control instructions for executing the microcontroller's functions, including check routines for controlling the first and the second charging processes.

The chargeable emergency battery units advantageously each comprise a number of NiCd battery cells.

The connecting devices advantageously comprise a twin cable with a cigarette lighter plug, arranged for connecting the device according to the invention to a circuit in which the starting battery is included, via a cigarette lighter contact in the vehicle.

### BRIEF DESCRIPTION OF THE DRAWINGS

Further details, features and advantages of the present invention will become apparent on reading the following description of a preferred embodiment of the invention, given by way of illustrative and non-limiting example only, and from the accompanying drawings, in which:

FIG. 1 is a block diagram schematically illustrating the construction of a preferred embodiment of a device according to the invention,

FIG. 2 is a detail drawing of an arrangement for the switch devices illustrated in FIG. 1,

FIG. 3 is a block diagram schematically illustrating the construction of an alternative embodiment of a device according to the invention.

### DETAILED DESCRIPTION OF THE INVENTION

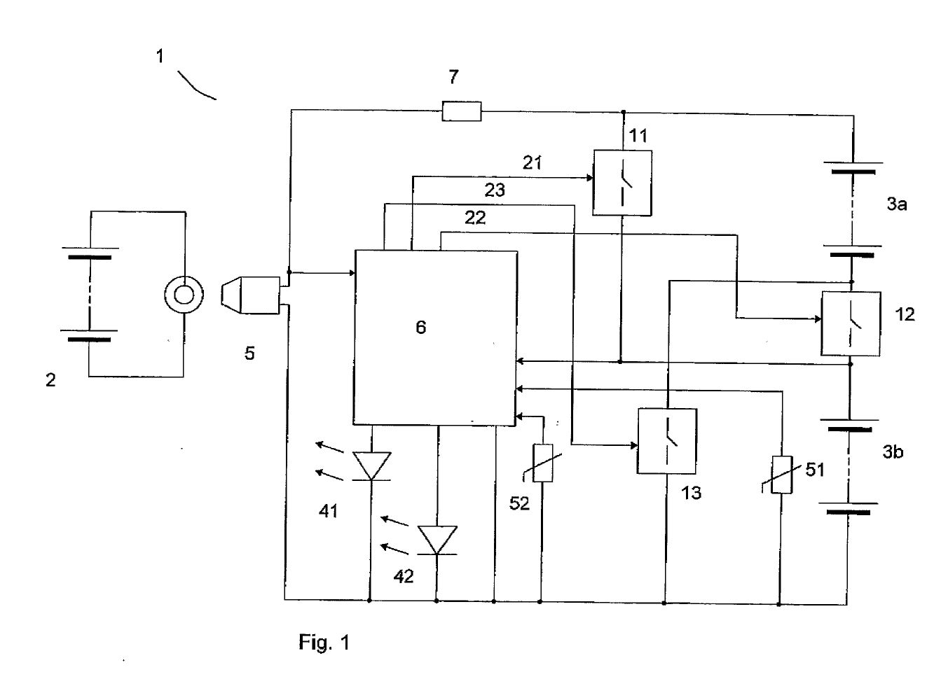

FIG. 1 is a block diagram schematically illustrating the construction of a device 1 for charging a starting battery 2 in a vehicle (not illustrated), according to the invention. The device 1 comprises a chargeable emergency battery, divided into two separate emergency battery units 3a, 3b. Each emergency battery unit 3a, 3b preferably consists of a number of chargeable cells connected in series. Each individual cell may be connected to one or more additional cells in parallel. The cells are of a known per se type, preferably with high electrical capacity relative to the cell's volume and weight. In a preferred embodiment NiCd cells are used. In a specially preferred embodiment each emergency battery unit 3a, 3b comprises NiCd cells connected in series.

The device 1 further comprises control circuits for controlling a first charging process or course for charging the starting battery 2 and for controlling a second charging process or course for charging the emergency batteries 3a, 3b. In the embodiment in FIG. 1 this is illustrated by the fact that the control circuits comprise, amongst other things, electronic switch devices 11, 12, 13.

The device 1 further comprises connecting devices 5 for electrical connection to a circuit in which the starting battery is included. These connecting devices preferably comprise a twin cable with a cigarette lighter plug arranged for coupling the device to an electrical circuit in which the starting battery 2 is included, via a cigarette lighter contact in the vehicle. Alternatively or in addition the connecting devices 5 may comprise components for connecting directly to the poles of the starting battery, for example connecting cables provided with crocodile clips.

The control circuits in the device 1 further comprise a control device 6 which is arranged for comparing the starting battery's voltage and a voltage for at least one of the emergency battery units, and arranged for controlling at least one of the first and the second charging processes as a function of at least this comparision.

More specifically, the control device 6 is arranged for measuring the starting battery's voltage and the voltage of at least one of the emergency battery units. This is illustrated by having the voltage on the positive pole of the emergency battery 3b entered as an input to the control device 6. Alternatively or in addition the positive pole of the emergency battery 3a could be entered as an input to the control device 6. The control device 6 is furthermore arranged to control at least one of the first and the second charging processes as a function of at least these voltages.

For this purpose the control device 6 comprises a processor device, which in a specially preferred embodiment is in the form of a microcontroller. The microcontroller comprises a processing unit, at least one storage device, input and output circuits and a clock unit. The storage device comprises an area from which the processing unit at least can read, and which contains a program containing control instructions for the execution of the microcontroller's functions, including check routines for controlling the first and second charging processes, where for controlling at least one of the first and the second charging processes, account is taken of the measurements of the starting battery's voltage and a voltage for the emergency battery, and where in addition consideration is advantageously given to measurements of the temperature at or near the emergency battery and possibly in the rest of the surroundings. The storage device further comprises an area from which the processing unit can both read and to which it can write, and which may contain temporary data for, amongst other things, measurements and calculations.

The input circuits in the microcontroller comprise circuits for analog to digital conversion, which convert external analog signals to digital data which can be processed in the microcontroller. These analog signals include voltage signals which are directly derived from the starting battery's and the emergency battery's voltage, and voltage signals from temperature measurements at or near the emergency battery and possibly in the surroundings. The voltage signals from temperature measurements may be produced by means of known per se temperature sensors, including semiconductor sensors or temperature-sensitive resistors. This is provided by the choice of components and techniques which are well-known to those skilled in the art.

Alternatively, the control device 6 may be realised by means of programmable logic circuits, separate logic circuits, application-specific integrated circuits (ASIC), analog integrated circuits, including operational amplifiers, comparators or a combination of different types of circuits.

The control device 6 includes a first temperature sensor device 51, installed at or near an emergency battery unit, specially illustrated as the emergency battery unit 3b, for measuring a temperature at or near the emergency battery unit. The control device 6 is arranged to control at least one of the first and the second charging processes as a function of this temperature.

A problem with NiCd cells and similar chargeable battery cells is that rapid charging is not possible or desirable if the cell temperature is lower than approximately 0° C. to 5° C., on account of gas formation and overpressure. This temperature range is highly typical for the application of the present invention, as opposed to battery chargers for other applications.

It is desirable that, after having undergone the first charging process, the device according to the invention should be ready to perform a new, first charging process as quickly as possible. Thus the second charging process, which has to be undergone before a new first charging process can take place, should be of the shortest possible duration. In order to achieve this, particularly at low ambient temperatures, it is advantageous to take account of temperature measurements, particularly at or near an emergency battery unit and possibly also in the surroundings, during the control of the second charging process.

Furthermore, the cell temperature for the emergency battery in the first or second charging process should not exceed approximately 45° C.

The control device therefore advantageously also includes a second temperature sensor device 52 for measuring an ambient temperature, and is arranged to control at least one of the first and the second charging processes as a function of this temperature.

The measurement of ambient temperature is employed in order to avoid rapid charging of the emergency battery units at an ambient temperature lower than approximately 0° C. to 5° C. or higher than approximately 45° C. When such ambient temperature measurements are performed, the second charging process is not carried out as a rapid charging.

To implement the first charging process, the ambient temperature measurement may be employed in order to reduce the average current in the second process if the measured ambient temperature is high, for example over 30° C., and particularly approaching 45° C.

Additionally, the control device 6 may comprise a third temperature sensor device (not illustrated) for measuring a temperature at or near the emergency battery unit 3a, and be arranged to control at least one of the first and second charging processes as a function of this temperature.

The temperature sensor devices, the corresponding signals which are passed to the control device 6, and the processing of the signals there, where at least the temperature measured at or near at least one of the emergency battery units is employed for control of at least one of the first and the second charging processes, provide optimal charging processes with high energy utilisation and a long life for the emergency battery units.

The control device includes electrical outputs which are connected to the electronic switch devices 11, 12, 13. Since the control device switches these outputs off and on as required, a governed control can be obtained of the current through each individual switch device, thereby providing a controlled pulse width modulation of these currents.

The pulse width modulation of the charging current in the first and the second charging processes respectively results in minimal energy loss, particularly compared to solutions where a variable resistor, such as a PTC resistor, is used instead in order to vary the charging current.

The control device 6 also includes a first electrical output in order to transmit a signal indicating that the first charging process is in progress. Similarly, the device 1 includes a first indicator 41 which is connected to this first output.

The control device 6 also includes a second electrical output in order to transmit a signal indicating that the charge contained in the emergency battery is below a given limit value. Similarly, the device 1 includes a second indicator 42 which is connected to this second output.

The indicators 41 and 42 may each be of the optical type, for example a light diode, or of the acoustic type, for example a piezoelectric sound transmitter.

The control device 6 preferably comprises a microcontroller containing a program for controlling the outputs to the switch devices and the indicators, as a function of the measured values for voltages and temperatures.

The program executed by the microcontroller may provide various known per se methods for charging, such as rapid charging and “trickle” charging, depending on the measured values. The microcontroller provides fully automatic checking, control and monitoring of both the first and the second charging processes, thereby dispensing with any mechanical switches, and achieving an extremely simple operation of the device.

In the embodiment illustrated in FIG. 1 the emergency battery comprises two separate emergency battery units 3a, 3b, each with nominal voltage less than the starting battery's nominal voltage. In more specific terms, the nominal voltage for each emergency battery unit is approximately 9V, while the nominal voltage for the starting battery is approximately 12V.

The electronic switch devices 11, 12, 13 which are covered by the control circuits for controlling the first charging process for charging the starting battery 2 and for controlling the second charging process for charging the emergency batteries 3a, 3b are controlled by control signals, designated 21, 22 and 23 respectively. The control signals are supplied by the control device 6.

The switch device 11 is connected to the positive pole of the first emergency battery unit 3a and to the positive pole of the second emergency battery unit 3b.

The switch device 12 is connected to the negative pole of the first emergency battery unit 3a and to the positive pole of the second emergency battery unit 3b.

The switch device 13 is connected to the negative pole of the first emergency battery unit 3a and to the negative pole of the second emergency battery unit 3b.

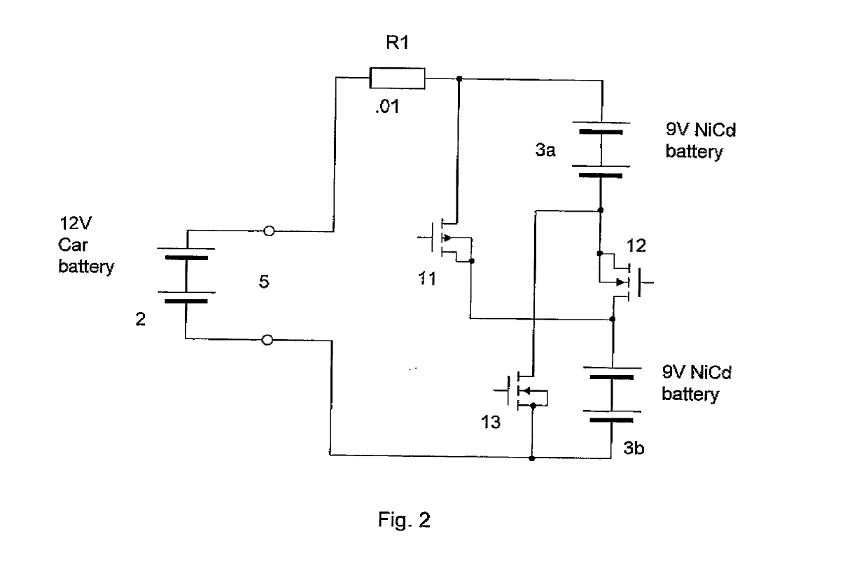

The electronic switch devices 11, 12, 13 preferably comprise MOSFET transistors, as illustrated in FIG. 2. Alternatively, other FET transistors may be employed, and possibly electronic/electrical switch devices of another known type, including relays, which are suitable for controlling a current with average value of the order of up to approximately 10 A, and a peak value of up to approximately 40 A. The connection of control signals to the switch devices 11, 12, 13 is not illustrated in FIG. 2.

During the first charging process, when the emergency battery units have to charge the starting battery, the control signals 21, 23 are inactive, with the result that the switch devices 11, 13 are open. When the control signal 22 is active, the two emergency battery units 3a, 3b will be connected in series to the circuit in which the starting battery 2 is included. The two emergency battery units 3a, 3b, connected in series, provide a voltage which is high enough for the starting battery 2 to be supplied with a charge.

During the second charging process, when the starting battery has to charge the emergency battery units, the control signal 22 is inactive, with the result that the switch device 12 is open. When the control signals 21, 23 are both active, the two emergency battery units 3a, 3b will be connected in parallel to the circuit in which the starting battery 2 is included. The starting battery 2 can thereby provide a voltage which is high enough for the emergency battery units 3a, 3b, connected in parallel, to be supplied witb a charge.

This method of connecting the emergency battery units in series and in parallel for the first and second charging processes respectively results is far less power/energy loss than the use of a boost circuit for providing a sufficiently high charging voltage.

The resistor 7 illustrated in FIG. 1 indicates a resistor for measuring current, a so-called “sense” or “drop” resistor, which typically is a power resistor with a low resistance value, for example 0.01 Ω. If such a resistor 7 is implemented, the voltage drop over the resistor can be electrically entered (not illustrated) into an analog input for the control device 6, thus enabling the control device to provide a signal which expresses the charging current in the first or second charging process. This signal can be employed by the control device 6 as an additional input value, in addition to the previously mentioned voltages and temperatures, for regulating the charging current during the first or the second charging process.

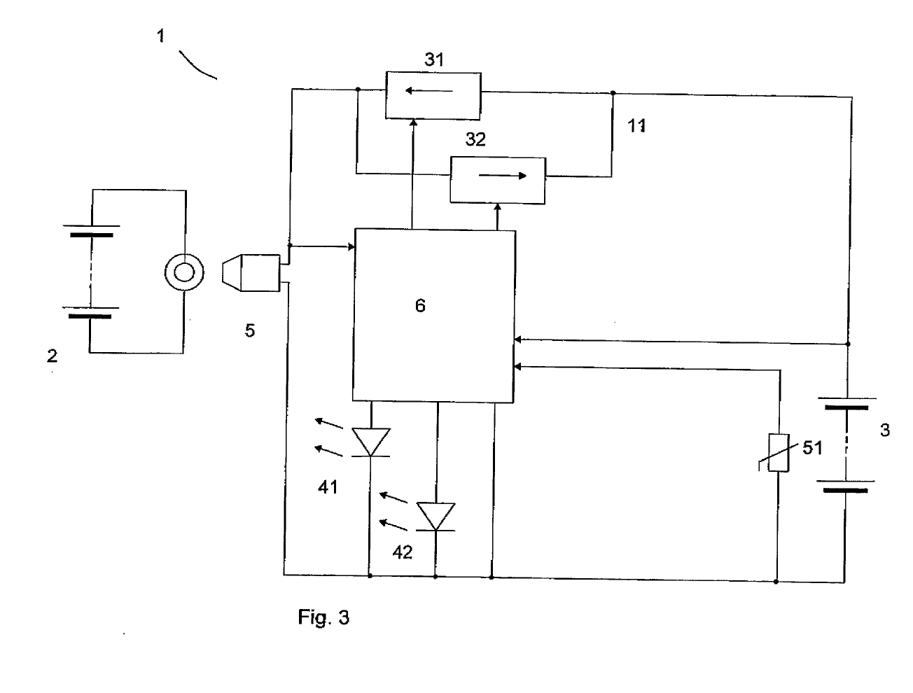

FIG. 3 is a block diagram illustrating the construction of an alternative embodiment of a device according to the invention.

The device illustrated in FIG. 3 comprises a chargeable emergency battery 3. The emergency battery 3 preferably consists of a number of chargeable cells connected in series. Each individual cell may be connected to one or more additional cells in parallel. The cells are of a known per se type, preferably with high electrical capacity relative to the cell's volume and weight. In a preferred embodiment NiCd cells are employed.

The device further comprises control circuits for controlling a first charging process for charging the starting battery and for controlling a second charging process for charging the emergency battery. In the illustrated embodiment this is illustrated by a separate control circuit unit 32 for controlling the first charging process, and a separate control unit 32 for controlling the second charging process. The control circuits for controlling the first and the second charging processes, however, may have common components, and do not need to be physically separated, as is indicated in the figure in order to illustrate the fundamental mode of operation.

The device further comprises connecting devices 5 for electrical connection to a circuit in which the starting battery is included, in the same way as the embodiment shown in FIG. 1.

The control circuits in the device comprise a control device 6 which is arranged for measuring the starting battery's voltage and the emergency battery's voltage. Furthermore, the control device 6 is arranged to control at least one of the first and the second charging processes as a function of at least these voltages.

The control device 6 advantageously comprises a processor device, which in a specially preferred embodiment is composed of a microcontroller, in the same way as the embodiment in FIG. 1, but as explained above it may be realised by other types of circuits.

The control device 6 comprises a first temperature sensor device 51, as in the embodiment in FIG. 1, and may also comprise second and third temperature sensor devices (not illustrated) in accordance with the explanation in connection with the embodiment in FIG. 1.

The control device 6 further comprises a first and a second electrical output connected to indicators, in the same way as the embodiment in FIG. 1.

In the embodiment in FIG. 3 the emergency battery 3 has higher nominal voltage than the starting battery's 2 nominal voltage. In a specially preferred embodiment, the emergency battery's nominal voltage is of the order of 18V, as opposed to the starting battery's nominal voltage of 12V. This means that the first charging process can consist in a direct electrical connection, which is preferably interrupted in a controlled manner, between the emergency battery 3 and the starting battery 2. In this embodiment the control circuits for controlling the first charging process comprise circuits for connecting the emergency battery, at least for periods, directly to the connecting device against the starting battery during the first charging process.

In order to subsequently carry out charging of the emergency battery from the starting battery, from the starting battery's voltage a charging voltage must be provided which is higher than the emergency battery's nominal voltage. For this purpose the control circuits for controlling the second charging process comprise a direct voltage converter circuit in order to provide during the second charging process, at least for periods, a charging voltage to the emergency battery which is higher than the starting battery's voltage. In a specially preferred embodiment a charging voltage is supplied to the emergency battery which is of the order of 24V.

When a direct voltage converter circuit is used to supply an increased charging voltage, a power loss is created in the converter circuit. An advantage of the present alternative embodiment of the invention in FIG. 3 over the aforementioned known device from U.S. Pat. No. 5,637,978 is that a power loss of this kind occurs in the second charging process, and not in the first charging process. This is clearly advantageous, since the requirement for a minimal loss of power is highly critical during the first charging process, where only a limited amount of energy is available. Correspondingly, the requirement for minimal power loss is not so critical during the second charging process, where a large amount of energy, generally from an essentially fully-charged starting battery or from a dynamo when the engine is running, is available. Moreover, the power loss is also less during the second process, where the charging current may advantageously be less than during the first process, thereby preventing unwanted heat loss and the need to convey heat away from the device.

A second advantage of the present alternative embodiment of the invention over the known device is that the direct voltage converter circuit can be designed for a smaller operating current when it forms part of the charging circuit in the second charging process, and not in the first charging process. This is due to the fact that the charging current in the second charging process can advantageously be less than the charging current in the first charging process, which in turn is due to the fact that the time which is available in the second charging process is greater than the time which is available in the first charging process.

The direct voltage converter circuit may be implemented by various techniques, for example corresponding to the boost-converter technique which is employed, amongst others, in the aforesaid U.S. Pat. No. 5,637,978, albeit in the opposite direction, in order to provide a sufficiently high charging voltage for the starting battery from the emergency battery, with the drawbacks which this entails. The content of the publication is hereby included as reference.

Other techniques for direct voltage converter circuits which may be employed in order to generate an output direct voltage which is higher than an input direct voltage are known per se for those skilled in the art under the descriptions flyback, forward, push-pull and sepic.

For both the aforementioned embodiments in FIGS. 1 and 3, all of the components in the device 1, as well as the connecting devices 5, are advantageously collected in an encapsulation, where the emergency battery units are replaceably mounted in a part of the encapsulation which can be opened, and where a cable which forms part of the connecting devices 5 is securely connected to the encapsulation. The two indicators 41 and 42 are preferably in the form of light diodes of different colours, mounted in such a way that they are easily visible from the outside of the encapsulation, or alternatively the indicator 41 is in the form of a light diode, while the indicator 42 is in the form of a piezoelectric sound transmitter.

The invention which is described in the above provides a device for charging a starting battery in a vehicle, which is highly energy-efficient, compact, reliable and easy to operate compared with previously known solutions.

It will of course be understood that the invention is not limited to the specific details described herein, which are given by way of example only.

For instance, although the control device 6 is specified as being arranged for measuring the starting battery's voltage and the voltage of at least one of the emergency battery units, the comparision between the two voltages could alternatively be accomplished by monitoring the direction and magnitude of the charging current, e.g. by measuring the voltage drop over the series resistor 7, during the charging processes.

Those skilled in the art will thus evidently realise that many modifications and variations of the present invention viewed in the light of the above description may be implemented without deviating from the scope of the invention, as it is defined in the following claims.

1. A device (1) for charging a starting battery (2) in a vehicle, comprising
a number of chargeable emergency battery units (3; 3a, 3b)
control circuits for controlling a first charging process for charging the starting battery (2) and for controlling a second charging process for charging the emergency battery units (3; 3a, 3b),
connecting devices (5) for electrical connection to a circuit in which the starting battery (2) is included, characterized in that the control circuits comprise a control device (6) arranged for comparing the starting battery's voltage and a voltage for at least one of the emergency battery units, and arranged for controlling at least one of the first and the second charging processes as a function of at least this comparision, and that the control device (6) comprises a first temperature sensor device (51) for measuring a temperature at or near an emergency battery unit, and is arranged for controlling at least one of the first and the second charging processes as a function of this temperature.

2. A device according to claim 1, characterized in that it comprises one emergency battery unit (3), where the emergency battery unit has higher nominal voltage than the starting battery's nominal voltage, and that the control circuits for controlling the first charging process comprise circuits arranged to connect the emergency battery unit directly to the connecting device against the starting battery for periods during the first charging process, and that the control circuits for controlling the second charging process comprise a direct voltage converter circuit in order to supply a charging voltage to the emergency battery unit which is higher than the starting battery's voltage for periods during the second charging process.

3. A device according to claim 1, characterized in that it comprises at least two emergency battery units (3a, 3b), each with nominal voltage less than the starting battery's nominal voltage, and that the control circuits for controlling the first charging process comprise electronic switch devices (11, 12, 13) in order to connect the at least two emergency battery units in series for periods during the first charging process, and that the control circuits for controlling the second charging process comprise electronic switch devices (11, 12, 13) in order to connect the at least two emergency battery units in parallel for periods during the second charging process.

4. A device according to one of the claims 1-3, characterized in that the control device (6) comprises a second temperature sensor device (52) for measuring an ambient temperature, and is arranged for controlling at least one of the first and the second charging processes as a function of this temperature.

5. A device according to one of the claims 1-3, characterized in that the control device (6) includes a first electrical output for transmitting a signal indicating that the first charging process is in progress, and that the device (1) comprises a first indicator (41) connected to the said first output.

6. A device according to one of the claims 1-3, characterized in that the control device (6) includes a second electrical output for transmitting a signal indicating that the charge contained in the emergency batteries is below a given limit value, and that the device (1) includes a second indicator (42) connected to the said second output.

7. A device according to one of the claims 1-3, characterized in that the control device (6) includes a microcontroller comprising a processing unit, at least one storage device, and input and output circuits, where the storage device comprises an area containing a program with control instructions for executing the microcontroller's functions, including check routines for controlling the first and the second charging processes.

8. A device according to claim 7, characterized in that the chargeable emergency battery units (3; 3a, 3b) each comprise a number of NiCd battery cells.

9. A device according to claim 8, characterized in that the connecting devices (5) comprise a twin cable with a cigarette lighter plug, arranged for connecting the device (1) to a circuit in which the starting battery (2) is included via a cigarette lighter contact in the vehicle.
